(19) United States
(12) Patent Application Publication
(10) Pub. No.: US 2003/0158824 A1
(43) Pub. Date: Aug. 21, 2003

(54) Electronic transaction mediation method, electronic transaction mediation apparatus, and combination generating method

(76) Inventor: Hideyuki Aisu, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/395,079

(22) Filed: Mar. 25, 2003

Related U.S. Application Data
(63) Continuation of application No. PCT/JP00/06574, filed on Sep. 25, 2000.

(51) Int. Cl. G06F 17/60; G06F 17/00

(52) U.S. Cl. 705/400; 705/5; 705/8; 705/26; 705/37

(57) ABSTRACT

A first module acquires a plurality of transaction conditions each including a plurality of items, from a plurality of terminals corresponding to a plurality of users via a network, a first memory device stores the transaction conditions acquired, a second module generates several combinations of the transaction conditions stored in the first memory device based on the items of each of the transaction conditions, a second memory device stores the combinations, and a third module presents each of the combinations stored in the second memory device to several of the terminals which involved in the each of the combinations by submitting one of several of transaction conditions is included in the each of the combinations.

### CROSS-REFERENCE TO RELATED APPLICATIONS

This is a Continuation Application of PCT Application No. PCT/JP00/06574, filed Sep. 25, 2000, which was not published under PCT Article 21(2) in English.

### BACKGROUND OF THE INVENTION

1. Field of the Invention

In recent years, electronic commercial transactions supported by the development of the Internet technologies have increasingly prevailed. For example, as mediation business on the Internet, an inverse auction system (Price Line patent: U.S. Pat. No. 5,794,207) in which a mediator (mediation server) finds a seller that matches a purchase condition registered by a consumer is known. In this system, for example, a consumer submits a purchase condition of a desired item, i.e., “want to buy a Tokyo—New York two-way air ticket within 300,000 yen” to a mediator. The mediator transfers the purchase condition to respective companies (companies A, B, and C). The respective companies give quotations to the mediator on the basis of the condition. Assume that the quoted prices of the respective companies are 320,000 yen (A), 310,000 yen (B), and 290,000 yen (C). The mediator compares the quotations of the respective companies, selects an item that matches the condition of consumer's choice, and advises the consumer of the contents of the item.

2. Description of the Related Art

Also, mediation business in which a mediator acquires and accumulates item information presented by sellers, and provides such information to a consumer (like the Internet version of mail order service) is known (Jpn. Pat. Appln. KOKAI Publication Nos. 10-320470 and 10-240823). With this business, a plurality of pieces of item information of respective companies are stored in a server, and a consumer selects an item that matches his or her desired condition from the stored information. Since item information has fixed contents presented by each company, a consumer must compromise on his or her desired condition to some extent.

In this manner, the conventional electronic commercial transaction system is designed to close a one-to-one transaction between the agent and consumer, but not to mediate any complicated transaction with at least multiple service providers or receivers, e.g., to close one transaction by combining a plurality of agents or to close a plurality of transactions by combining a plurality of agents and a plurality of customers.

### BRIEF SUMMARY OF THE INVENTION

The present invention relates to an electronic transaction mediation method and electronic transaction mediation system, which mediate transactions among a plurality of parties involved via, e.g., the Internet as a medium.

It is, an object of the present invention to provide an electronic transaction method and electronic transaction system, which can mediate not only a one-to-one transaction between two parties, i.e., the agent and consumer, but also a complicated transaction among three or more parties involved including at least multiple agents or consumers unlike in the prior art.

According to embodiment of the present invention, acquiring a plurality of transaction conditions each including a plurality of items, from a plurality of terminals corresponding to a plurality of users via a network; storing the transaction conditions acquired, in a first memory device; generating several combinations of the transaction conditions stored in the first memory device based on the items of each of the transaction conditions; storing the combinations, in a second memory device; and presenting each of the combinations stored in the second memory device to several of the terminals which involved in the each of the combinations by submitting one of several of transaction conditions included in the each of the combinations.

With this operation a complicated transaction among three or more parties involved can be easily mediated.

### BRIEF DESCRIPTION OF THE SEVERAL VIEWS OF THE DRAWING

FIG. 1 is a block diagram showing an example of the overall arrangement of an electronic transaction mediation system according to the present invention;

FIG. 2 is a flow chart for explaining the processing operation of a transaction mediation apparatus shown in FIG. 1;

FIG. 3 is a table showing a storage example of desired transaction conditions presented from the agent side;

FIG. 4 is a table showing a storage example of desired transaction conditions presented from the customer side;

FIG. 5 is a flow chart for explaining the processing operation of the transaction mediation apparatus shown in FIG. 1;

FIG. 6 is a flow chart for explaining the processing operation of the transaction mediation apparatus shown in FIG. 1;

FIG. 7 shows an example of a combination candidate search tree;

FIG. 8 is a flow chart for explaining the processing operation of the transaction mediation apparatus shown in FIG. 1;

FIG. 9 shows registered data of desired transaction conditions on the agent side;

FIG. 10 shows registered data of desired transaction conditions on the customer side;

FIG. 11 shows a display example of a combination candidate displayed on a GUI window of an agent terminal;

FIG. 12 shows a display example of a combination candidate displayed on a GUI window of a customer terminal;

FIG. 13 shows a display example of a combination candidate displayed on a GUI window of an agent terminal;

FIG. 14 shows registered data of desired transaction conditions on the agent side stored in a database, after combination candidate data corresponding to a closed transaction is deleted;

FIG. 15 shows registered data of desired transaction conditions on the customer side stored in a database, after combination candidate data corresponding to a closed transaction is deleted;

FIG. 16 shows a display example of a combination candidate displayed on a GUI window of a customer terminal;

FIG. 17 shows a display example of a combination candidate displayed on a GUI window of an agent terminal;

FIG. 18 is a flow chart for explaining the processing operation when the transaction mediation apparatus shown in FIG. 1 mediates free-entry transactions among a plurality of carriers of joint transport, and customers; and

FIG. 19 is a flow chart for explaining the processing operation when the transaction mediation apparatus shown in FIG. 1 mediates free-entry transactions among a plurality of carriers of joint transport, and customers.

### DETAILED DESCRIPTION OF THE INVENTION

An embodiment of the present invention will be described hereinafter with reference to the accompanying drawings.

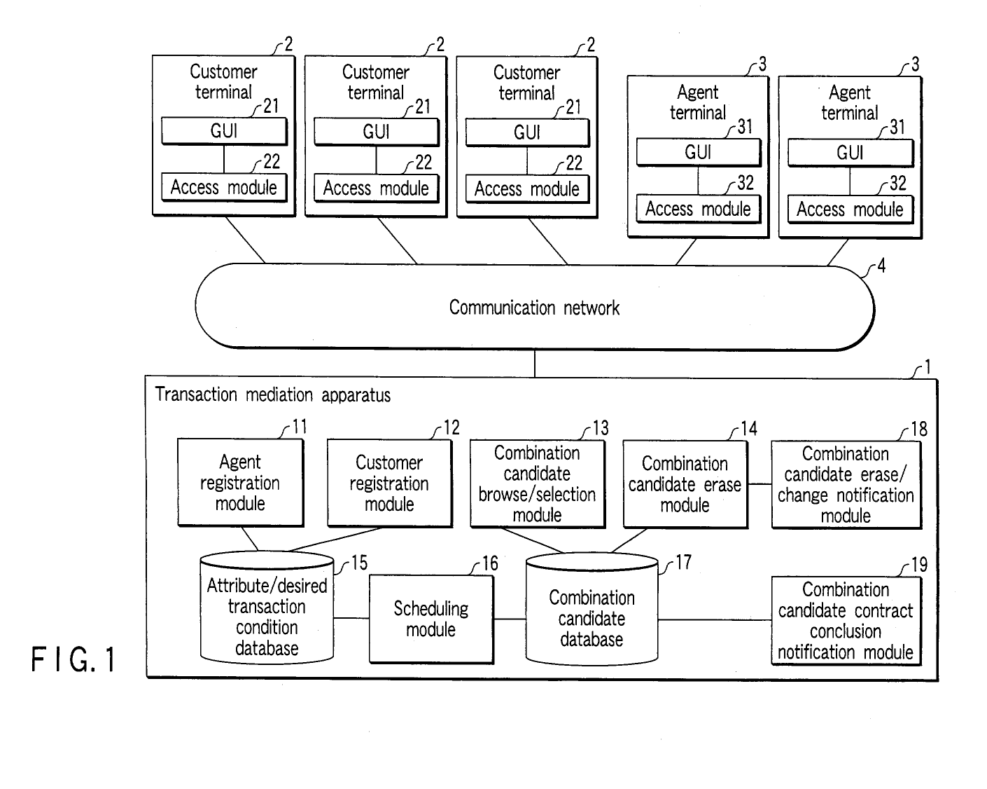

FIG. 1 shows an example of the overall arrangement of an electronic transaction mediation system according to an embodiment of the present invention. In this system, a transaction mediation apparatus 1 of a service center managed by a transaction mediator, a plurality of (e.g., three in this case) customer terminals 2, and a plurality of (e.g., two in this case) agent terminals 3 are connected via a communication network 4 such as the Internet or the like to be able to communicate with each other.

The transaction mediation apparatus 1 comprises an agent registration module 11, customer registration module 12, combination candidate browse/selection module 13, combination candidate erase module 14, attribute/desired transaction condition database 15 (to be also simply referred to as a database 15 hereinafter), scheduling module 16, combination candidate database 17 (to be also simply referred to as a database 17 hereinafter), combination candidate erase/change notification module 18, and combination candidate contract conclusion notification module 19.

Each customer terminal 2 comprises a GUI (Graphical User Interface) 21 used to input data such as customer attributes, desired transaction conditions, and the like, to present information sent from the transaction mediation apparatus 1, and so forth, and an access module 22 used to access the transaction mediation apparatus 1 by establishing connection to the communication network 4.

Each agent terminal 3 comprises a GUI 31 used to input data such as agent attributes, desired transaction conditions, and the like, to present information sent from the transaction mediation apparatus 1, and so forth, and an access module 32 used to access the transaction mediation apparatus 1 by establishing connection to the communication network 4. Note that the functions of the customer and agent terminals may be implemented by a versatile browser of an Internet terminal, and user authentication may be made using the user ID, password, and the like upon accessing the transaction mediation apparatus 1.

The agent registration module 11 receives data such as agent attributes, desired transaction conditions, and the like input using the GUI 31 of each agent terminal 3 via the communication network 4, so as to acquire data such as agent attributes, desired transaction conditions, and the like from many unspecified, agents who have the right of entry to transactions as agent entry data, and registers them in the attribute/desired transaction condition database 15.

From each agent terminal 3, the desired transaction conditions and the like of the corresponding agent, which have already been registered in the database 15 can be browsed and changed. Note that the agent registration module 11 may be arranged in each agent terminal 3.

The customer registration module 12 receives data such as customer attributes, desired transaction conditions, and the like input using the GUI 21 of each customer terminal 2 via the communication network 4, so as to acquire data such as customer attributes, desired transaction conditions, and the like from many unspecified, customers who have the right of entry to transactions as customer entry data, and registers them in the attribute/desired transaction condition database 15.

From each customer terminal 2, the desired transaction conditions and the like of the corresponding customer, which have already been registered in the database 15 can be browsed and changed. Note that the customer registration module 12 may be arranged in each customer terminal 2.

The desired transaction conditions registered from the agent registration module 11 and customer registration module 12 in the database 15 include, e.g., conditions that pertain to work contents and a desired fee, and may also include, e.g., a work start location, work end location, work start time, work end time, and the like. For example, if a work as a transaction target is a joint transport work, each agent and customer register data such as the package contents and load, a pickup location as the work start location, a destination as the work end location, a desired pickup time as the work start. time, a package arrival time as the work end time, and the like, as the desired transaction conditions.

The attribute/desired transaction condition database 15 saves data such as agent and customer attributes, desired transaction conditions, and the like to be able to search the database using attributes and desired transaction conditions as search keys.

The scheduling module 16 generates a plurality of combination candidates on the basis of the desired transaction conditions saved in the attribute/desired transaction condition database 15, so as to meet the desired transaction conditions of both the agent and customer at the same time. The combination candidates can include a combination of desired transaction conditions of a plurality of agents, and those of one customer, a combination of desired transaction conditions of one agent and those of a plurality of customers, and a combination of desired transaction conditions of a plurality of agents and those of a plurality of customers.

Such combination candidates are generated, e.g., every time the registered contents of the database 15 are updated, and the generated combination candidates are stored in the desired transaction condition combination candidate database 17. Upon completion of generation of all possible desired transaction condition combination candidates without generating repetitive combination candidates, the scheduling module 16 is at a halt, e.g., until the registered contents of the attribute/desired transaction condition database 15 are updated.

For example, if a work as a transaction target is a joint transport work, the scheduling module 16 generates a combination that can meet the package transport route, designated time, and transport fee registered by a given customer as desired transaction condition by combining a plurality of transport routes registered by a plurality of transportation companies as desired transaction conditions. Conversely, the scheduling module 16 generates a combination that can meet the desired loading ratio of a package transport route registered by a given agent as desired transaction conditions by combining a plurality of package transport works registered by a plurality of customers as desired transaction conditions.

On the other hand, if a work as a transaction target is a travel package, the scheduling module 16 generates a combination that can meet a tourist route, period, and fee that a given customer desired by combining a plurality of advance-sale tickets of transportation facilities registered by a plurality of railway transit/transport companies, accommodation tickets registered by a plurality of inn/hotel agents, and the like.

Of course, the module 16 may combine desired transaction conditions of a plurality of agents, and those of a plurality of customers.

The scheduling method of the scheduling module 16 is not particularly limited in this embodiment. However, it is desirable to define an arithmetic formula as a basis upon quantitatively estimating the satisfaction levels of agents and customers, and to extract fair combination candidates which can make the satisfaction levels of agents and customers included in the combination candidates equal as much as possible. Generation of fair combination candidates can increase a chance of simultaneously receiving approvals of all agents and customers associated with the combination candidates upon presenting these combination candidates to the agents and customers.

For example, the following method may be used. That is, the evaluation values of respective combination candidates are calculated using an objective function of optimization that increases the sum total of the satisfaction levels of all agents and customers included in each combination. A given number of combination candidates are listed by search in descending order of evaluation value. Then, only combination candidates, each of which has a minimum value of the satisfaction levels of agents and customers that is equal to or larger than a threshold value, are extracted from the listed combination candidates.

Upon reception of a combination candidate browse request from a given agent terminal 3 or customer terminal 2, the combination candidate browse/selection module 13 extracts combination candidates which include desired transaction conditions registered by the agent or customer of interest from the combination candidate database 17, and browsably transmits the extracted combination candidate data to the terminal. Also, the module 13 allows the agent or customer to select at least one combination candidate that the agent or customer can approve from the combination candidates browsed at the agent terminal 3 or customer terminal 2. Note that the combination candidate browse/selection module 13 can be arranged in the agent terminal 3 and customer terminal 2.

The combination candidate contract conclusion notification module 19 notifies all agents and customers who satisfy desired transaction conditions associated with a combination which is approved by both the agents and customers and corresponds to a concluded transaction, of combination candidates, accordingly.

The combination candidate erase module 14 erases all other combination candidates which include at least one of desired transaction conditions associated with a concluded transaction from the combination candidate database 17. Also, the module 14 notifies the customer terminal 2 and agent terminal 3, which are browsing the erased combination candidates, of information of the erased combination candidates using the combination candidate erase/change notification module 18, thus reflecting it on the browsing contents.

The processing operation of the transaction mediation apparatus 1 shown in FIG. 1 will be described below. Note that both the customer and agent will be referred to as a user.

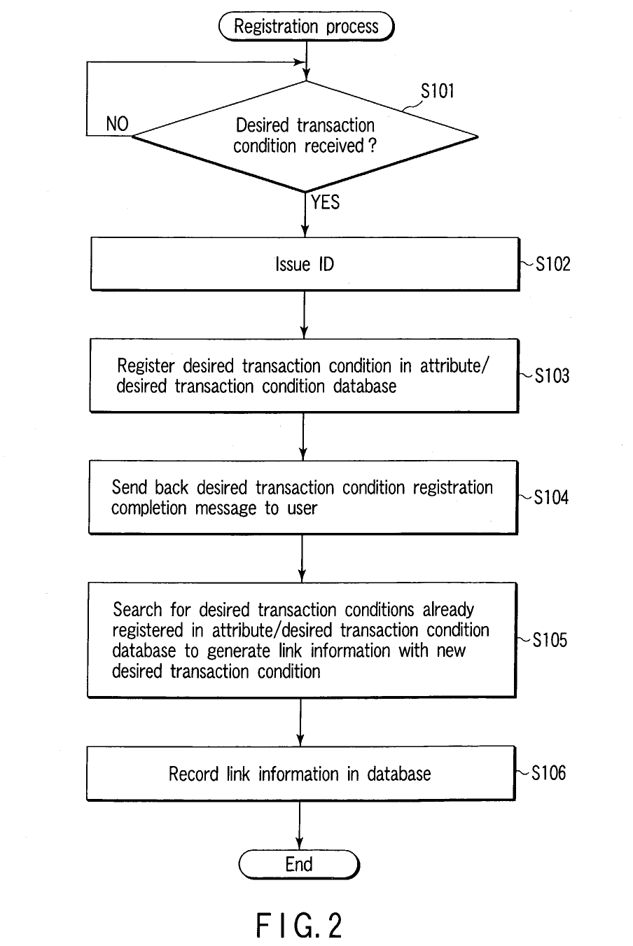

FIG. 2 is a flow chart for explaining the processing operation executed when the transaction mediation apparatus 1 accepts new desired transaction conditions from user terminals 2 and 3. A desired transaction condition includes information associated with the user ID and the contents of a work to be contracted, and also data of a work station location, work end location, possible work start time, possible work end time, and the like.

When the user establishes connection to the transaction mediation apparatus 1 of a service center using the GUI 21 or 31 of the terminal 2 or 3 and submits data of a new desired transaction condition, the agent registration module 11 or customer registration module 12 of the transaction mediation apparatus 1 receives that data (step S101), and issues an entry ID used to identify the desired transaction condition (step S102).

The module 11 or 12 registers the received desired transaction condition in the attribute/desired transaction condition database 15 together with the user ID (attribute) received at the same time (step S103), and notifies the user of completion of registration (step S104).

Furthermore, the attribute/desired transaction condition database 15 is searched to find all other desired transaction conditions which mutually meet some of each others' desired transaction conditions and can form one-to-one combinations with the newly registered desired transaction condition (step S105). Also, the entry IDs of the other found combinable desired transaction conditions are recorded in the database 15 as link information to allow cross-reference between the newly registered transaction condition and other combinable desired transaction conditions, so that the scheduling module 16 can use such information later to improve efficiency upon generating combination candidates (step S106). Note that the storage address information or the like of the desired transaction conditions may be used as link information place of the entry IDs.

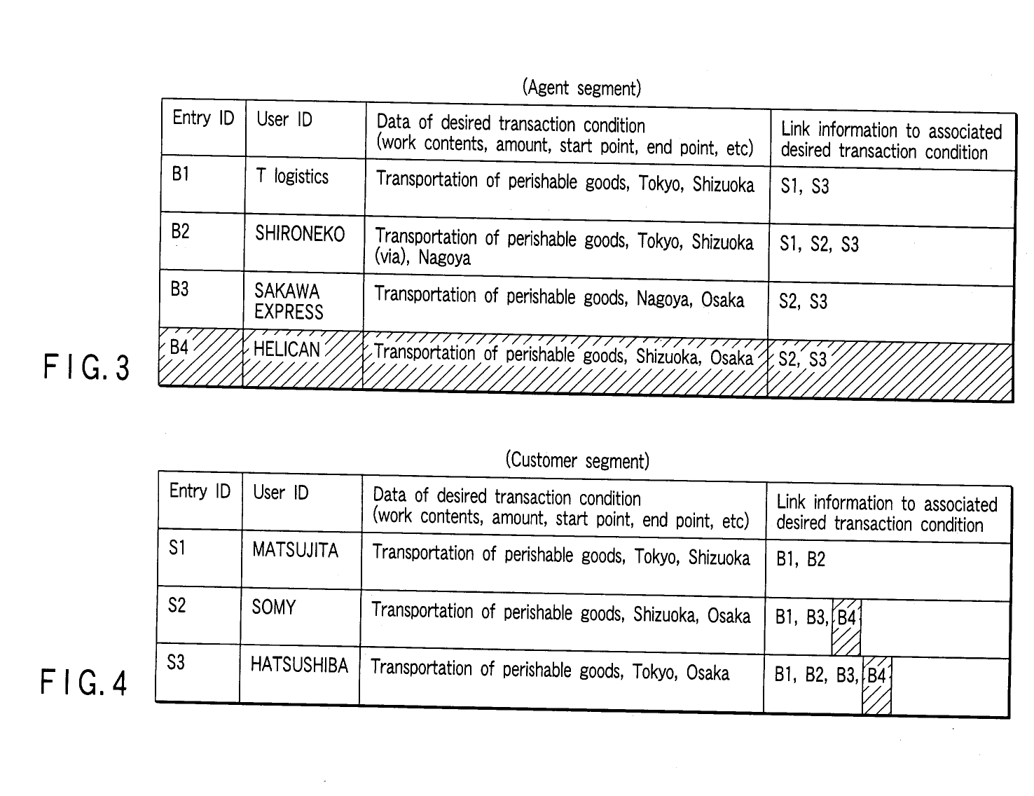

FIGS. 3 and 4 show examples of the registered contents stored in the attribute/desired transaction condition database 15 and, for example, show a case wherein transportation companies and customers are users. FIG. 3 shows the registered contents on the agent side (agent segment), and FIG. 4 shows the registered contents on the customer side (customer segment). Note that conditions associated with time are omitted from the desired transaction conditions for the sake of simplicity. One agent or customer may often enter a plurality of desired transaction conditions.

In this example, when a scheduled route of a transportation company and a package route designated by a customer include an overlapping route, since they may be included in an identical combination candidate, cross-link information is appended. For example, if entry ID “B4” in FIG. 3 is a newly registered desired transaction condition, since the newly registered desired transaction condition includes a route from Shizuoka to Osaka, entry IDs “S2” and “S3” as desired transaction conditions on the customer side which include that route are appended to link information of entry ID “B4” in FIG. 3. Also, entry ID “B4” is appended to link information of each of entry IDs “S2” and “S3” in the customer segment in FIG. 4.

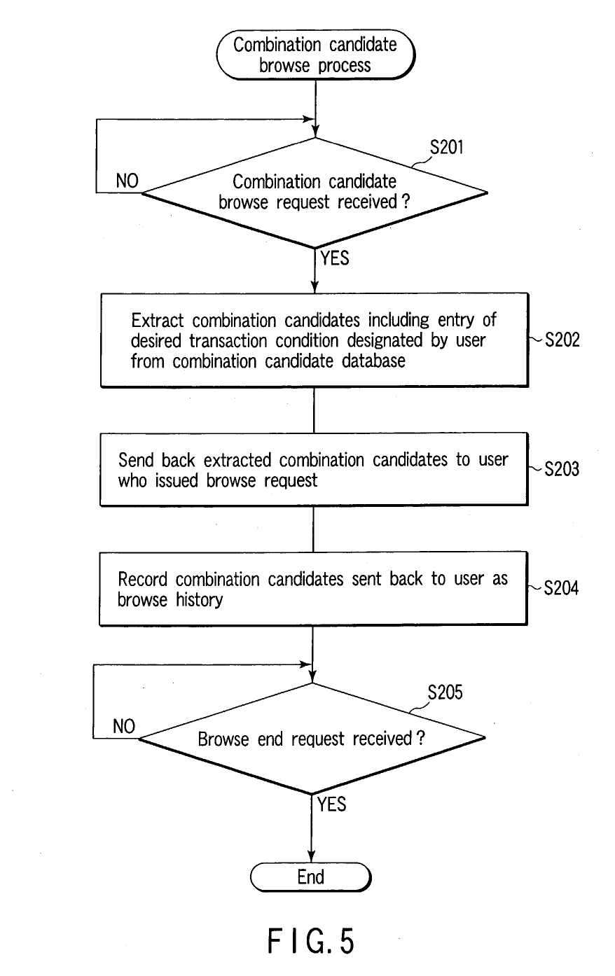

The processing operation executed when the transaction mediation apparatus 1 accepts a combination candidate browse request from the user will be described below with reference to FIG. 5. When the user establishes connection to the transaction mediation apparatus 1 using the GUI 21 or 31 of the terminal 2 or 3 and submits a browse request together with the entry ID of the desired transaction condition of his or her choice, the combination candidate browse/selection module 13 of the transaction mediation apparatus 1 receives that request (step S201). The module 13 searches the combination candidate database 17 to extract combination candidates that include the designated desired transaction condition (step S202). The extracted combination candidates are sent back to the user as the request source (step S203). Also, browse history information indicating the user and combination candidates that he or she is browsing is stored (step S204). The history information is saved until a browse end message is received from the user of interest (step S205). Note that the processes in steps S204 and S205 may be omitted.

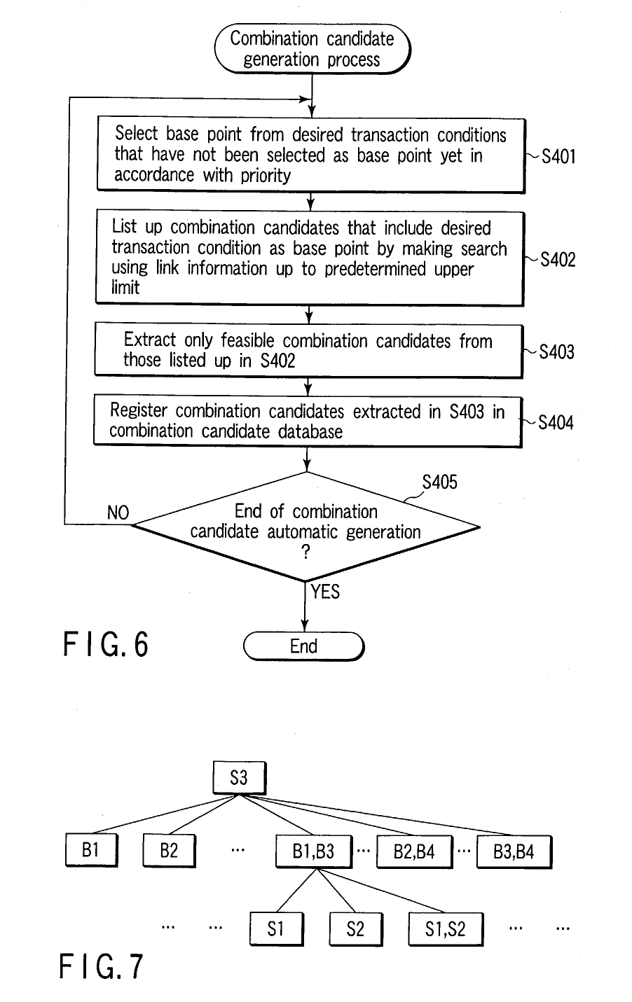

The processing operation for efficiently listing possible combinations, as a part of the process for generating combination candidates by the scheduling module 16, will be described below with reference to FIG. 6. Of combination candidates listed by this process, candidates whose satisfaction levels of agents and customers, which are converted into numerical values by the aforementioned method, are high, are recorded in the combination candidate database 17.

A desired transaction condition registered in the attribute/desired transaction condition database 15 is selected as a base point in accordance with priority (step S401). Priority may use the order of importance levels of users, or some determination methods such as a method of preferentially selecting a user with a high utilization ratio, a method of giving top priority to a user who has already issued a browse request, and the like may be used. Alternatively, a desired transaction condition, which has not been selected as a base point yet, or a newly registered desired transaction condition may be preferentially selected as a base point.

By conducting a search that traces the link information of the desired transaction condition selected as the base point, possible combination candidates are listed within a predetermined upper limit range (step S402).

The method of listing combination candidates in step S402 will be explained below with reference to a search tree shown in FIG. 7 used when the desired transaction condition with entry ID “S3” in FIG. 4 is selected as a base point. Respective nodes of the search tree shown in FIG. 7 indicate desired transaction conditions which are added to a parent node at that time. Also, the upper limit value of the number of desired transaction conditions which can be combined as one combination candidate is three on the customer side, and two on the agent side.

As can be seen from FIG. 4, a link information set appended to the desired transaction condition of entry ID “S3” is {B1, B2, B3, B4}. Combinations of desired transaction conditions as partial sets of this link information set can be combined with the desired transaction condition of entry ID “S3”.

Assume that the number of elements per node is 2 or less on the basis of the above upper limit value. That is, when the desired transaction condition of entry ID “S3” is selected as a base point, all partial sets {B1}{B2}, . . . , {B1, B3}, . . . , {B2, B4}, . . . , {B3, B4} including two or less elements of set {B1, B2, B3, B4} are listed as nodes expanded from that base point. That is, each of these partial sets of desired transaction conditions can form one combination candidate in combination with the desired transaction condition of entry ID “S3” as their parent node.

Furthermore, node {B1, B3} is expanded, i.e., nodes which are connected to node {B1, B3} are obtained. As shown in FIG. 3, since the sum set of link information sets of the desired transaction conditions with entry IDs “B1” and “B3” is {S1, S2, S3}, partial sets {S1}, {S2}, and {S1, S2} of set {S1, S2} of desired transaction conditions are obtained by excluding “S3” as one of combination elements of node {B1, B2} from that sum set are listed. That is, each of these partial sets of desired transaction conditions can form one combination candidate in combination with the desired transaction condition of entry ID “S3” in addition to set {B1, B3} of desired transaction conditions as their parent node. In this example, since the number of customers involved in a transaction has reached the upper limit “3” , node {S1, S2} is no more expanded.

As described above, by listing sets of desired transaction conditions expanded from a given node, adding partial sets of desired transaction conditions of each node to those of its parent node, and tracing these sets from each node in the base point direction, combination candidates corresponding in number to expanded nodes can be listed without omission. Upon expanding nodes, search pruning is made by checking if a given combination has already been listed during search.

Note that this search may be independently conducted prior to detailed constraint check and the aforementioned arithmetic operations of evaluation values based on the satisfaction levels of customers and agents. However, when the number of desired transaction conditions and the number of pieces of link information are large, combinatorial explosion occurs. A search method that makes evaluation value arithmetic operations for combinations of respective nodes during search, and preferentially expands a node with a higher evaluation value may be used to improve the efficiency. In such case, a best-first search algorithm, A* search algorithm, and the like are used to find combination candidates with a stronger chance of conclusion of a transaction without listing all candidates.

After combination candidates are listed, detailed constraint check is made based on conditions depending on respective combination candidates such as if all minimum required condition items of each desired transaction condition that forms each combination candidate are satisfied, if there is competition among customers or agents, and so forth (step S403). Then, the combination candidates are registered in the combination candidate database 17 (step S404).

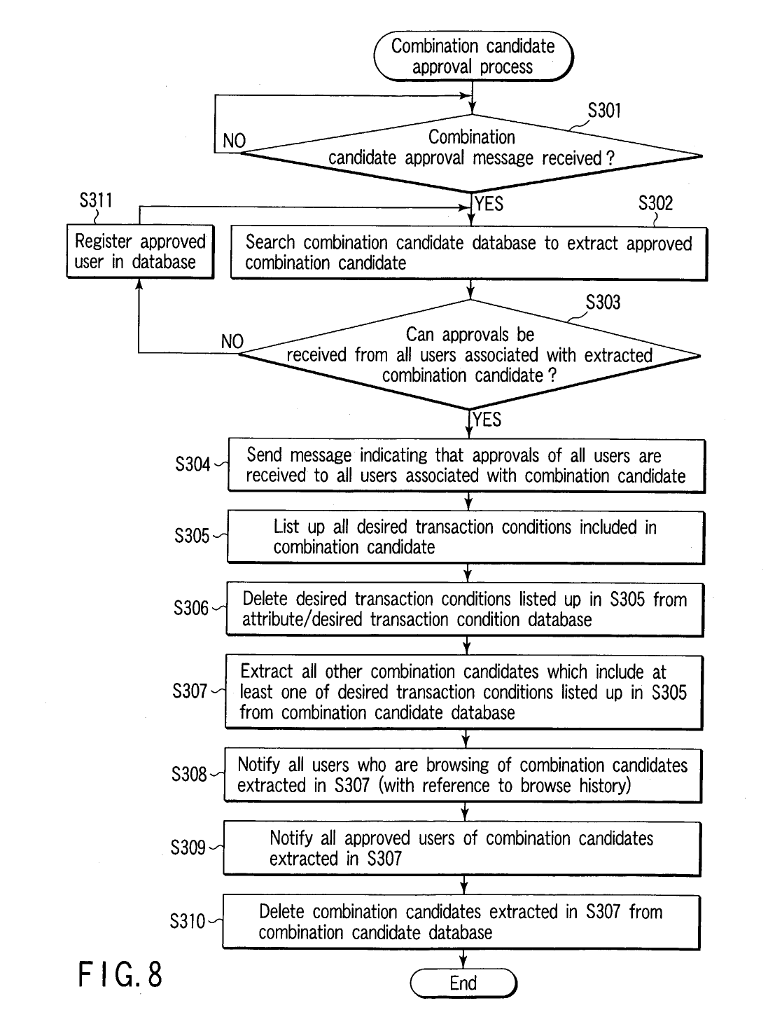

The processing operation executed when the user (to be referred to as user A for the sake of simplicity) who browsed the combination candidates approves a given combination candidate (to be referred to as combination candidate X for the sake of simplicity) will be explained below with reference to FIG. 8.

When user A establishes connection to the transaction mediation apparatus 1 using the GUI 21 or 31 of the terminal 2 or 3 and submits an approval message together with the ID of combination candidate X, the combination candidate browse/selection module 13 receives it (step S301). Upon reception of this approval message, the combination candidate browse/selection module 13 extracts combination candidate X from the combination candidate database 17 (step S302). If at least one of users (to be referred to as users B and C for the sake of simplicity) other than user A who registered all desired transaction conditions which form combination candidate X does not approve these desired transaction conditions, information indicating that user A has approved combination candidate X is recorded in the database 17 (step S303, step S311).

If all users B and C other than user A have approved combination candidate X (step S303), the combination candidate contract conclusion notification module 19 sends a message indicating that approvals of everyone concerned have been received to all users A, B, and C (step S304). After that, these users close a detailed contract by themselves.

When combination candidate X has received approvals of everyone concerned, desired transaction conditions which form this combination candidate X can no longer be repetitively used in other combination candidates. Hence, related post-processes are executed in step S305 and subsequent steps.

The combination candidate erase module 14 lists all desired transaction conditions which form combination candidate X (step S305), and deletes the listed desired transaction conditions from the attribute/desired transaction condition database 15 (step S306). Also, the module 14 deletes all combination candidates which include at least one of the listed desired transaction conditions from the combination candidate database 17 (step S307, step S310). Furthermore, the combination candidate erase/change notification module 18 advises users who are browsing the deleted combination candidates accordingly with reference to the aforementioned browse history information (step S308). Also, the module 18 sends an approval invalidated message to users who have already approved the deleted combination candidates (step S309). Note that the processes in step S304 and subsequent steps need not always be executed in the above specific order. Also, steps S308 and S309 may be omitted.

In a process for making an agent or customer approve one of browsed desired transaction condition combination candidates, some agents or customers may approve by default without browsing combination candidates and making an approval operation.

In such case, such agent or customer may give an advance notice of such default approval to the transaction mediation apparatus 1 without browsing combination candidates as long as desired transaction conditions are met.

When the user (agent and customer) approves one of desired transaction condition combination candidates that he or she has browsed, he or she may designate a condition to be approved in advance, and a plurality of combination candidates which satisfy this condition may be automatically approved.

Furthermore, for example, the customers may generate a list of agents with which they can transact, and send the list to the transaction mediation apparatus 1 in advance. If a combination is formed by only agents included in this list, it may be approved by default.

When a party concerned mediates a transaction among three parties or more, it becomes difficult to receive approvals of all associated agents and customers unless a mediator proposes combination candidates that do not make a specific agent or customer particularly suffer disbenefit, and a transaction cannot be easily concluded in electronic commercial transactions with many unspecified users. Such combination candidates are manually generated by a mediator so far, but the present invention can automate a series of mediation jobs including this generation process, and can be applied to automation of free-entry work transaction mediation of every kinds of business.

For example, upon planning a package tour, a travel bureau can form a package tour that can meet customer's requirements by combining a plurality of agents such as transportation facilities, hotels, restaurants, and the like in accordance with conditions such as a time, location, and the like. Unlike conventional inverse auction of tickets, the package tour formed in this way is always commercially viable for the agent side.

In a helper dispatching service business for care for the aged, in order to dispatch disengaged helpers to different time zones designated by a plurality of customers who live in different areas, requirements of a plurality of customers and availability of a plurality of helpers are combined to timely generate and provide an efficient schedule to the customers. The schedule proposed in this way is also convenient for the agent side. For example, with this schedule, one helper can efficiently visit persons who need care and live in an identical area, in turn.

Examples of free-entry transactions among a plurality of carriers of joint transport, and customers will be described in detail hereinafter.

A system conventionally proposed in free-entry electronic transactions of joint transport is either of auction type in which carriers present transport conditions and desired prices, and a plurality of customers bid off, or of inverse auction type in which customers offer conditions first. In this case, a transaction between one agent and one customer is to be mediated, but their desired transport conditions rarely perfectly match, and one of the agent and customer often compromises.

According to the present invention, since mediation of complicated transactions among a plurality of carriers and a plurality of customers can be automated, a transaction mediation service that can simultaneously meet desired transport conditions of both the agents and customers and can bring certain advantages to them quickly with low cost by combining some desired conditions.

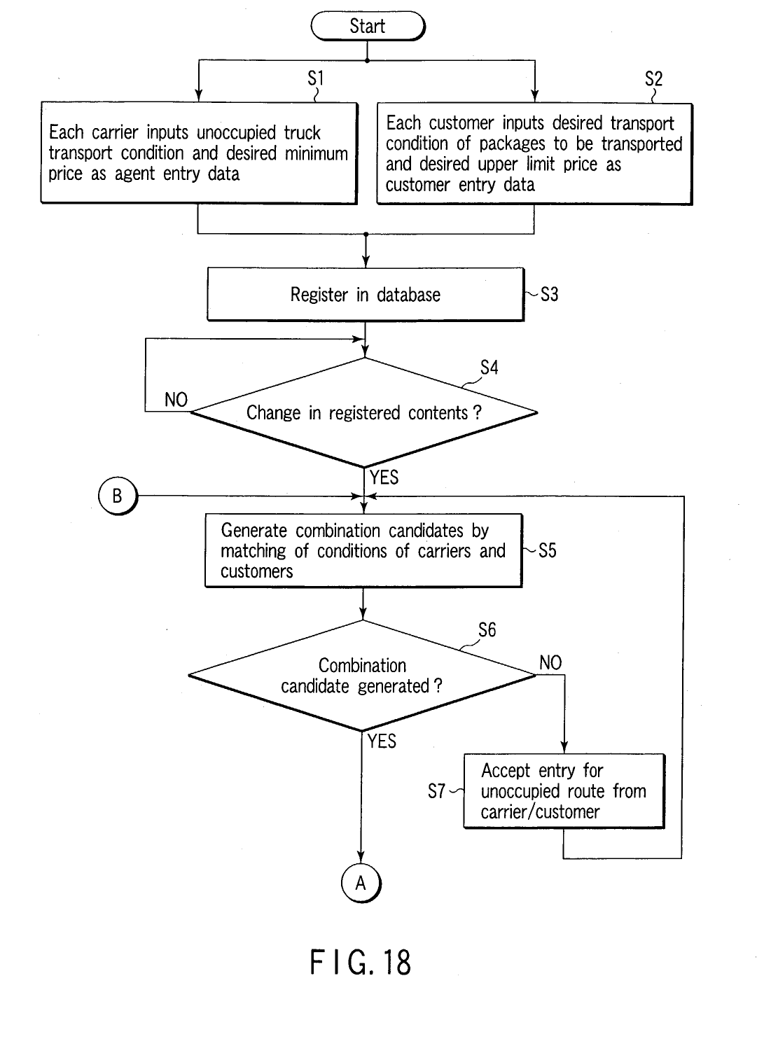

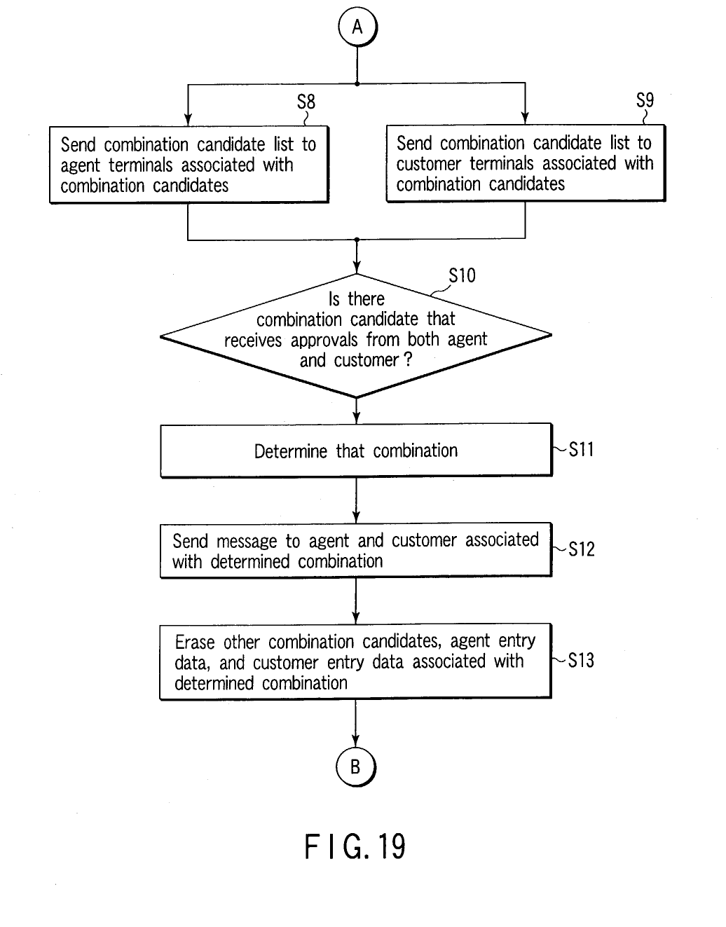

The processing operation of the transaction mediation apparatus 1 will be described below with reference to the flow charts shown in FIGS. 18 and 19.

Respective carriers input transport conditions (transport routes, loads, desired minimum prices, and the like) of unoccupied trucks from their agent terminals 3, and the input conditions are registered in the database 15 (step S1, step S3).

Respective customers input desired transport conditions (transport routes, quantities, desired upper limit prices, and the like) of packages to be transported from their customer terminals 2, and the input conditions are registered in the database 15 (step S2, step S3).

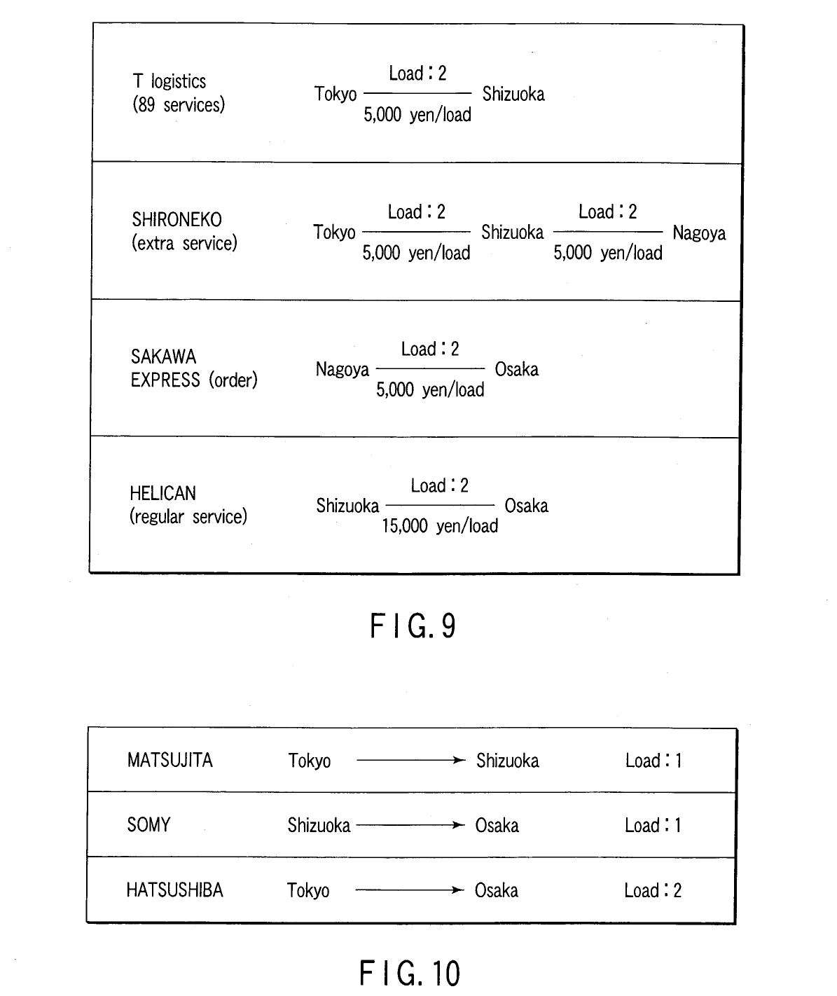

FIG. 9 shows the attributes and desired transaction conditions on the agent side, which are registered in the database 15. FIG. 9 shows a case wherein a plurality of (for example, four in this case) carriers have registered, as their desired transaction conditions, the transport routes, loads, and desired minimum prices per load of the respective routes. For example, as can be seen from FIG. 9, in case of carrier “SHIRONEKO”, the transport route is “Tokyo—Shizuoka—Nagoya”, the load that can be transported between Tokyo and Shizuoka is “2”, and the transportation charge per module load “1” in that route is 5,000 yen. For the sake of simplicity, the load is expressed by only a numerical value with reference to the module load. That is, in this example, in case of transportation from Tokyo to Shizuoka with the load “2”, the transportation charge of 10,000 yen is required.

FIG. 10 shows the attributes and desired transaction conditions on the customer side, which are registered in the database 15. FIG. 10 shows a case wherein a plurality of (for example, three in this case) customers have registered, as their desired transaction conditions, the transport routes and load. For example, in case of customer “HATSUSHIBA”, the transport route is “Tokyo—Osaka”, and the load in this route is “2”.

The scheduling module 16 detects, for example, that the registered contents of the database 15 have been updated (step S4), and makes matching among the desired transaction conditions to generate a plurality of combination candidates as transaction candidates (step S5). In this case, combination candidates are generated using the aforementioned search tree, and combination candidates with higher feasibility are then extracted from the generated combination candidates on the basis of the constraint check and evaluation values. In this case, a description of such process will be omitted.

In step S5, upon searching for combinations to have a given transaction condition as a base point, no combination candidate that can meet the desired transaction conditions of both the customers and agents can be generated in some cases. In such case (step S6), for, e.g., an unoccupied route, entries from carriers may be accepted at an auction or those from customers may be accepted at an inverse auction (step S7).

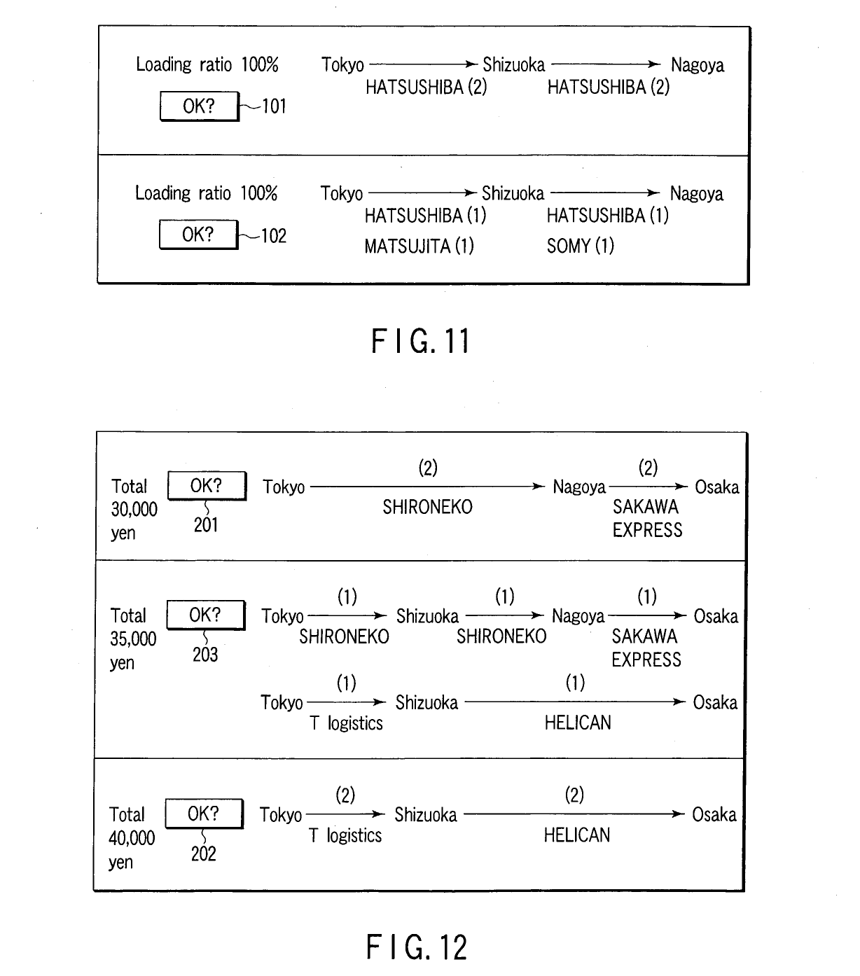

The combination candidates generated in step S5 are stored in the combination candidate database 17. Upon receiving a browse request, customers and agents who form candidates are informed of the combination candidates. For example, a combination candidate list shown in FIG. 11 is transmitted to the agent terminal 3 of carrier “SHIRONEKO”, and is displayed on the GUI 31 (step S8 in FIG. 19). On the other hand, a combination candidate list shown in FIG. 12 is transmitted to the customer terminal 2 of customer “HATSUSHIBA”, and is displayed on the GUI 21 (step S9 in FIG. 19).

The combination candidates generated by the scheduling module 16 will be explained first with reference to FIGS. 11 and 12.

For example, as can be seen from FIG. 10, customer “HATSUSHIBA” desires transportation from Tokyo to Osaka with the load “2”. The desired upper limit price as the transportation charge in that route is “40,000 yen”.

As can be seen from FIG. 9, carrier “SHIRONEKO” has availability with the load “2” between Tokyo and Shizuoka, and that with the load “2” between Shizuoka and Nagoya. On the other hand, as can be seen from FIG. 9, carrier “SAKAWA EXPRESS” has availability with the load “2” between Nagoya and Osaka. Hence, by combining these two carriers, transportation that can meet the desired transaction condition of customer “HATSUSHIBA” can be realized. In this case, the transportation charge is “30,000 yen”. In addition, combinations of carriers which can meet the desired transaction condition of customer “HATSUSHIBA” shown in FIG. 12 are similarly available. Then, the combination candidate browse/selection module 13 generates a list shown in FIG. 12 by re-arranging these combinations with the transportation charges of 40,000 yen or less in ascending order of transportation charge, and provides the generated list to the customer terminal 2. Alternatively, combination candidates may be re-arranged in ascending order of transport time. That is, combination candidates are preferably re-arranged with reference to an item of customer's choice on which the customer gives the greatest importance.

On the other hand, if carrier “SHIRONEKO” transports packages of “HATSUSHIBA” from Tokyo to Nagoya, its loading ratio becomes 100%. Also, if carrier “SHIRONEKO” transports packages of “HATSUSHIBA” and “MATSUJITA” by “1” each between Tokyo and Shizuoka, and also packages of “HATSUSHIBA” and “SOMY” by “1” each from Shizuoka to Nagoya, its loading ratio becomes 100%. It is desired for the agents if all unoccupied routes are occupied at the loading ratio of 100%. Hence, the combination candidate browse/selection module 13 generates a list shown in FIG. 11 by re-arranging these combinations in descending order of load, and provides that list to the agent terminals 3. Alternatively, the combinations may be rearranged in descending order of sales. That is, combination candidates are preferably re-arranged with reference to an item of agent's choice on which the agent gives the greatest importance.

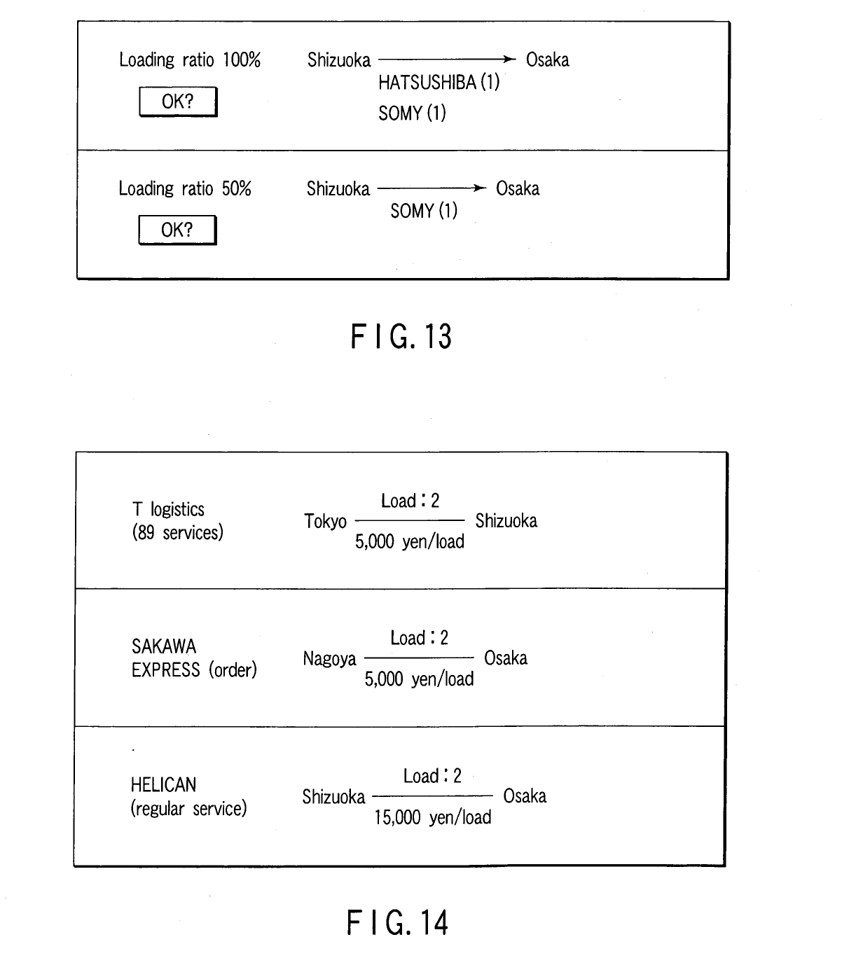

In this case, a combination list shown in FIG. 13 is displayed on the agent terminal 3 of carrier “HELICAN”.

Assume that “OK” buttons 101 and 201 on the lists shown in FIGS. 12 and 11, which are displayed on the GUIs 21 and 31 of the terminals of customer “HATSUSHIBA” and carrier “SHIRONEKO”, are selected to send messages indicating that they approve a combination candidate, which is offered first in the lists shown in FIGS. 12 and 11, to the combination candidate browse/selection module 13 (step S10). Furthermore, assume that an approval message to the same combination candidate is sent from the agent terminal of “SAKAWA EXPRESS” to the combination candidate browse/selection module 13. Thus, a work transaction among three parties, i.e., two carriers “SHIRONEKO” and “SAKAWA EXPRESS”, and one customer “HATSUSHIBA” is concluded (step S11). Note that a transaction is concluded on a first-come-first-served basis in an order that approvals are received first from both the customer and agent.

Upon approving a combination candidate, a method other than that described above may be used. For example, in place of offering combination candidates to the customer or agent terminals, when a customer or agent offers a minimum condition that can be approved in advance, a combination candidate that meets the minimum condition may be automatically approved. For example, if customer “HATSUSHIBA” notifies in advance the transaction mediation apparatus 1 that all transaction candidates which have the transportation charge of 40,000 yen or less and allow transportation with the load “2” from Tokyo to Osaka ″ are approved, all transaction candidates shown in FIG. 12 are automatically approved by customer “HATSUSHIBA”.

For example, when customer “HATSUSHIBA” approves the second uppermost transaction candidate with the transportation charge of 35,000 yen of those shown in FIG. 12, it may be determined that customer “HATSUSHIBA” also approves all transaction candidates above the approved one, i.e., transaction candidates that meet the desired transaction conditions of customer “HATSUSHIBA” more satisfactorily.

The combination candidate contract conclusion notification module 19 sends a transaction conclusion message to agents and customers who form the combination candidate corresponding to the concluded transaction (step S12).

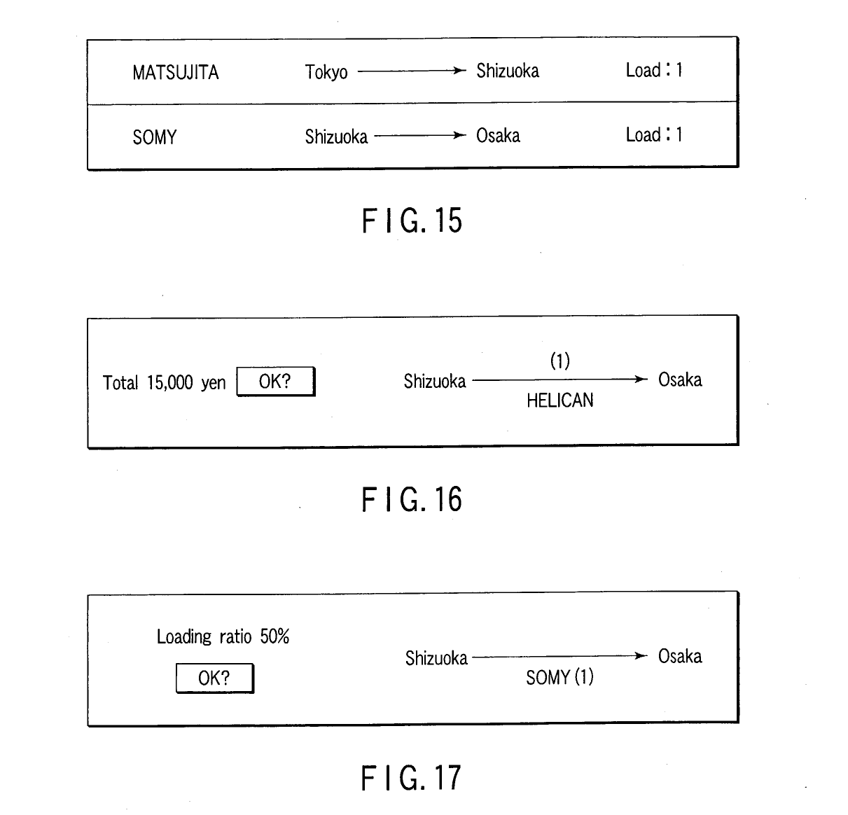

The combination candidate erase module 14 erases the combination candidate corresponding to the concluded transaction from the database 17, and also erases the attributes and desired transaction conditions of agents and customers, which are registered in the database 15 and are invalidated upon conclusion of the transaction (step S13). As a result, the registered contents of the database 15 are updated (see FIGS. 14 and 15), and the flow advances to step 5S in FIG. 18. Then, the scheduling module 16 makes matching of the desired transaction conditions of agents and customers on the basis of the updated registered contents shown in FIGS. 14 and 15 and generates combination candidates again.

On the other hand, upon conclusion of the transaction between carrier “SHIRONEKO” and customer “HATSUSHIBA”, the combination candidate erase/change notification module 18 notifies the agent and customer terminals, to which combination candidates including these agent and customer are offered as lists, that the combination candidate corresponding to the concluded transaction is erased. Also, the module 18 sends a message indicating that approvals are invalidated and combination candidates are changed accordingly to other customers/agents who have already approved the erased combination candidate. Upon reception of a request of a list of changed combination candidates in response to the message, the combination candidate browse/selection module 13 provides a new list to the request source.

For example, upon conclusion of the transaction between carrier “SHIRONEKO” and customer “HATSUSHIBA”, since a combination candidate including the desired transaction condition of customer “HATSUSHIBA” is deleted from those including carrier “HELICAN” in FIG. 13, a newly generated combination candidate list shown in FIG. 17 is displayed on the terminal 3 of carrier “HELICAN”. That is, a combination candidate between customer “SOMY” and carrier “HELICAN”, which transports packages of customer “SOMY” from Shizuoka to Osaka although the loading ratio is 50%, is displayed on the list. On the other hand, the same combination candidate is displayed as a list on the terminal of customer “SOMY”, as shown in FIG. 16.

Note that the processes in the aforementioned steps are not always executed in turn, and are normally parallel executed as a plurality of processes.

In the above example, only carriers enter transactions. In addition, warehousers and the like may enter as agents while offering the locations of warehouses, service periods, and the like as desired transaction conditions.

The method of the present invention described in the embodiment of the present invention can be stored in a recording medium such as a magnetic disk (floppy disk, hard disk, or the like), an optical disk (CD-ROM, DVD, or the like), a semiconductor memory, or the like, and can be distributed as a program that can be executed by a computer.

Note that the present invention is not limited to the aforementioned embodiment, and various modifications may be made without departing from the scope of the invention when it is practiced. Furthermore, the embodiment includes inventions of various stages, and various inventions can be extracted by appropriately combining a plurality of required constituent elements disclosed in this application. For example, even when some required constituent elements are deleted from all the required constituent elements disclosed in the embodiment, an arrangement from which those required constituent elements are deleted can be extracted as an invention if (at least one of) the problems described in the paragraphs of problems to be solved by the invention can be solved and (at least one of) the effects described in the effect of the invention can be obtained.

As described above, the present invention is effective in the fields of communication techniques used to provide an electronic transaction mediation service that mediates transactions among a plurality of parties involved using the Internet as a medium, and the fields that manufacture and use an apparatus and program required to provide this service.

What is claimed is:

1. An electronic transaction mediation method comprising:
acquiring a plurality of transaction conditions each including a plurality of items, from a plurality of terminals corresponding to a plurality of users via a network;
storing the transaction conditions acquired, in a first memory device;
generating several combinations of the transaction conditions stored in the first memory device based on the items of each of the transaction conditions;
storing the combinations, in a second memory device; and
presenting each of the combinations stored in the second memory device to several of the terminals which involved in the each of the combinations by submitting one of several of transaction conditions included in the each of the combinations.

2. A method according to claim 1, further comprising,
receiving a plurality of approval message which approves one of the combinations, each of the approval message being sent from one of several of the terminals involved in the one of the combinations;
sending a transaction conclusion message to each of the several of the terminals involved in the approved combination, when approvals are obtained from the terminals involved in the combination.

3. A method according to claim 2, further comprising,
erasing other combinations stored in the second memory, which include at least one of the transaction conditions which is included in the approved combination, from the second memory device.

4. A method according to claim 1, further comprising,
receiving a require to change one of the transaction conditions stored in the first memory device, from one of the terminals.

5. A method according to claim 3, further comprising,
sending a notification that erases the first combination, to each of the several of the terminals which are presented the first combination or send the approval message for the first combination.

6. A method according to claim 1, further comprising,
calculating a satisfaction level of each of the several of the transaction conditions with respect to the each of the combinations stored in the second memory; and,
wherein presenting the each of the combinations stored in the second memory device includes presenting the each of the combinations according to the satisfaction level of the one of the several of the transaction conditions which is submitted by the each of the several of the terminals.

7. A method according to claim 2, further comprising,
calculating a satisfaction level of each of the several of the transaction conditions with respect to the each of the combinations stored in the second memory; and,
determining, when one of the approval message for a first combination of the combinations which includes a second transaction condition is received, a second combination of the combinations which includes the second transaction condition whose satisfaction level with respect to the second combination is higher than that of the second transaction condition with respect to the first combination is approved.

8. A method according to claim 2, further comprising,
calculating a satisfaction level of each of the several of the transaction conditions with respect to the each of the combinations stored in the second memory;
determining a first combination of the combinations which includes a second transaction condition whose satisfaction level with respect to the first combination is equal to or higher than a minimum level designated by one of the terminals which submits the second transaction condition is approved.

9. An electronic transaction mediation apparatus comprising:
a first module which acquires a plurality of transaction conditions each including a plurality of items, from a plurality of terminals corresponding to a plurality of users via a network;
a first memory device which stores the transaction conditions acquired;
a second module which generates several combinations of the transaction conditions stored in the first memory device based on the items of each of the transaction conditions;
a second memory device which stores the combinations; and
a third module which presents each of the combinations stored in the second memory device to several of the terminals which involved in the each of the combinations by submitting one of several of transaction conditions included in the each of the combinations.

10. An apparatus according to claim 9, further comprising,
a fourth module which receives a plurality of approval message for the purpose of approving one of the combinations, each of the approval message being sent from one of several of the terminals involved in the one of the combinations;
a fifth module which sends a transaction conclusion message to each of the several of the terminals involved in the approved combination, when approvals are obtained from the terminals involved in the combination.

11. An apparatus according to claim 10, further comprising,
a sixth module which erases other combinations stored in the second memory, which include at least one of the transaction conditions which is included in the approved combination, from the second memory device.

12. An apparatus according to claim 9, further comprising,
a seventh module which receives a require to change one of the transaction conditions stored in the first memory device, from one of the terminals.

13. An apparatus according to claim 11, further comprising,
an eighth module which sends a notification that erases the first combination, to each of the several of the terminals which are presented the first combination or send the approval message for the first combination.

14. An apparatus according to claim 9, further comprising,
a ninth module which calculates a satisfaction level of each of the several of the transaction conditions with respect to the each of the combinations stored in the second memory; and,
wherein the third module presents the each of the combinations to the several of the terminals according to the satisfaction level of the one of the several of the transaction conditions which is submitted by the each of the several of the terminals.

15. An apparatus according to claim 10, further comprising,
a ninth module which calculates a satisfaction level of each of the several of the transaction conditions with respect to the each of the combinations stored in the second memory; and,
a tenth module which determines, when one of the approval message for a first combination of the combinations which includes a second transaction condition is received, a second combination of the combinations which includes the second transaction condition whose satisfaction level with respect to the second combination is higher than that of the second transaction condition with respect to the first combination is approved.

16. An apparatus according to claim 10, further comprising,
a ninth module which calculates a satisfaction level of each of the several of the transaction conditions with respect to the each of the combinations stored in the second memory;
an eleventh module which determines a first combination of the combinations which includes a second transaction condition whose satisfaction level with respect to the first combination is equal to or higher than a minimum level designated by one of the terminals which submits the second transaction condition is approved.

17. A combination generating method comprising:
(a)generating a plurality of combinations of a plurality of conditions each including a plurality of items;
(b) storing the conditions in a first memory device;
(c) linking each one of the conditions stored in the first memory, to other conditions stored in the first memory device, at least one of the items of each of the other conditions meets at least one of the items of the one of the conditions;
(d) selecting a first condition of the conditions, to obtain a root node of a search tree;
(e) generating a plurality of first subsets, each element of each of the first subsets is an element of a set of conditions linked to the root node;
(f) connecting each of the first subsets to the root node as a node of the search tree;
(g) generating a plurality of second subset, when one of the node of the search tree having a plurality of elements, each element of each of the second subsets is an element of a set of conditions each linked to at least one of the elements of the one of the node;
(h) connecting each of the second subsets to the one of the node as a node of the search tree;
(i) repeating step (g)-(h) until a given convergence condition is satisfy, to obtain the search tree;
(j) generating a plurality of combinations of the conditions stored in the first memory device, by adding each element of one of a child node of the search tree to a set of conditions corresponding to a parent node to which the child node is subordinate.
